(19) United States
(12) Patent Application Publication
(10) Pub. No.: US 2026/0367122 A1
(43) Pub. Date: Nov. 19, 2026

(54) METHOD AND DEVICE FOR TRANSMITTING SIGNED METERING DATA FROM AN ENERGY MEASURING DEVICE TO A RECEIVING DEVICE

(71) Applicant: Siemens Aktiengesellschaft, Munchen (DE)

(72) Inventor: Rainer Hauser, Nürnberg (DE)

(21) Appl. No.: 19/681,370

(22) Filed: May 19, 2026

(30) Foreign Application Priority Data
May 19, 2025 (DE) 10 2025 119 306.1

(51) Int. Cl. G01R 22/06; H04L 9/32; H04L 67/02

(52) U.S. Cl. CPC G01R 22/063; H04L 9/3236; H04L 9/3247; H04L 67/02

(57) ABSTRACT

A method for transmitting metering data from an energy measuring device to a receiving device. The metering data is collected by the energy measuring device and stored. Then, a digital signature is generated over the metering data and also stored. The metering data and the signature are transmitted successively or jointly from the energy measuring device to the receiving device by way of a communication interface. The communication for the transmission in this case is in a stateless form, by transmitting the metering data and the signature as a response immediately upon a request by the receiving device without the exchange of session data.

### CROSS-REFERENCE TO RELATED APPLICATION

This application claims the priority, under 35 U.S.C. § 119, of German Patent Application DE 10 2025 119 306.1, filed May 19, 2025; the prior application is herewith incorporated by reference in its entirety.

### FIELD AND BACKGROUND OF THE INVENTION

The invention relates to a method for transmitting metering data from an energy measuring device to a receiving device. Furthermore, the invention relates to an energy measuring device for transmitting metering data to a receiving device. Furthermore, the invention relates to a receiving device for receiving metering data from an energy measuring device according to the invention. Furthermore, the invention relates to a system having at least one energy measuring device according to the invention and at least one receiving device according to the invention.

Energy measuring devices must have a display or screen for reading the energy meter readings. The reading is carried out manually, for example, and the energy meter readings are subsequently checked and signed by an authorized person. It would also be desirable to read such devices remotely via a communication link. Due to the obligation to provide evidence, operators of such devices must archive the read-out values (metering data, measurement data). Now it would seem obvious to import the counter readings directly into a database, which necessarily requires manual checking and signing by an authorized person, however. Today, there are already energy measuring devices which apply an electronic or digital signature to such metering data on request. These are then read out using special protocols, such as so-called smart meter protocols. However, this requires special readout software for the devices, which makes it possible to certify the energy measuring devices for the digital signature. This certification is time-consuming and costly.

### SUMMARY OF THE INVENTION

The primary object of the present invention is to simplify the transmission of signed metering data from an energy measuring device to a receiving device.

The above and other objects are achieved by the subjects of the independent patent claims. Advantageous developments of the invention are described by the dependent patent claims, the description and the figures.

With the above and other objects in view there is provided, in accordance with the invention, a method for transmitting signed metering data (N) from an energy measuring device to a receiving device, the method comprising:
collecting and storing the metering data by the energy measuring device;
generating and storing a digital signature over the metering data ; and
sequentially or jointly transmitting the metering data and the signature from the energy measuring device to the receiving device by way of a communication interface, wherein a communication for the transmission is in a stateless form, and the metering data and signature are transmitted as a response immediately upon a request by the receiving device without an exchange of session data.

According to this first aspect, the invention relates to a method for transmitting or supplying signed metering data from an energy measuring device to a receiving device. The metering data is collected by the energy measuring device and stored. Then, a digital signature over the metering data is generated and also stored. The metering data is thus available in the form of signed metering data. The metering data and the signature are then transmitted successively or jointly from the energy measuring device to the receiving device by means of a communication interface. The communication for the transmission in this case is in a stateless form, by transmitting the metering data and the signature as a response immediately upon a request or call from the receiving device without the exchange of session data.

This involves exploiting the property of a communication protocol or a distributed system to treat requests essentially as mutually independent transactions or processes. The communication nodes-in this case the energy measuring device and the receiving device-do not store a protocol state that contains the session data, for example. For example, session data consists of information about current or previous sessions or connections for communication between communication nodes. For example, it may contain user information or device information. The query is therefore in particular independent of the respective receiving device. This means that communication nodes with different architecture or software can also exchange the corresponding data.

Overall, this makes the communication particularly simple. The signed metering data can be queried and archived without the need for additional special software. This means that anyone can transmit the signed metering data in a particularly simple and automated manner. For the automation, for example, one or more energy measuring devices can be regularly queried using a simple script. For example, the response objects can be stored in a database or cloud of the receiving device.

The transmission of data or signals by means of the communication interface preferably refers in the present case to a bidirectional exchange. This means that the (stateless) communication can take place in both directions between the communication nodes (energy measuring device and receiving device).

The metering data is preferably measured data or measured values from one or more sensors of a sensor unit of the energy measuring device. The metering data preferably relates to energy meter readings. In other words, it contains in particular information indicating the energy consumption of a consumer connected to the energy measuring device. For example, the metering data can contain information about electricity consumption, energy consumption or power consumption or a related quantity, in the form of measured values. The metering data can also contain time information, for example, such as a date or time for the readout, or an identification number of the measuring device.

The energy measuring device and the receiving device are implemented as a client-resource architecture (formerly master-slave architecture). The energy measuring device is understood in this case to be a resource or transmitter, while the receiving device is understood to be the client or receiver. In this architecture, communication is based on the following principle: The receiver places a request and the sender responds with an appropriate response. Since the communication is stateless, the devices do not need to “introduce” or authenticate themselves to each other first. In principle, any device can send the request. The signature is used to validate or verify the metering data.

The receiving device is preferably MID-compliant (Measurement Instrument Directive) in accordance with Directive 2004/22/EC or compliant with calibration laws (Measurement EV-compliant). This means that the measuring device comprises an energy meter or sensors that promise 100 percent accuracy of the meter readings. For example, the receiving device may contain or be coupled with a server or a database for storing the signed metering data. From there, the stored data can be read out by an authorized body, for example, for audit purposes.

The invention includes embodiments that result in additional advantages.

In one embodiment, the signature is generated by means of a cryptographic hash function. This means that a cryptographic hash algorithm is applied to the metering data to generate the signature. A string, preferably of fixed length, which is usually specified in bits, is generated from data records of arbitrary length. The generated string is referred to as a digital fingerprint or cryptographic checksum. This string is the so-called hash value or hash, which is a digital code that is returned after the hash function is applied. To satisfy the requirements on a cryptographic hash function, the resulting hash value must be unique, reversible, and collision-resistant. For example, the hash function can be implemented using a suitable hash algorithm, such as SHA2 and SHA3.

In one embodiment, the signature is encrypted by means of public key authentication. This means that it is a key-dependent hash function. This is a well-known asymmetric cryptosystem that can be used to create digital signatures. The transmitter, in this case the energy measuring device, calculates a value (the signature) for a digital message using a secret signature key, the so-called private key. This value allows anyone to check the non-deniable authorship and integrity of the digital message, i.e., the metering data, using the public verification key, i.e., the so-called public key. For this purpose, the public key is stored once by each energy measuring device in a database that the receiving device can access. As a result, the authenticity and integrity of the measuring or metering data, in particular the meter readings, can be proven even years later.

In one embodiment, a REST API (Representational State Transfer Application Program Interface) is implemented for the stateless communication. The transmission is carried out by means of the HTTP protocol.

The communication interface in this configuration is preferably a radio interface (WLAN, mobile radio, . . . ). This means that the data is exchanged by radio or wirelessly. The request is therefore ultimately made via a browser query. In addition to the metering data, such as the counter reading, the response also has as its object a second object, namely the signature of the metering data object.

A REST API is a well-known architectural style that allows different terminal devices (energy measuring device and receiving device) to communicate over a network. The REST API enables communication even when the terminal devices are running on different underlying operating systems or architectures. This uses the HTTP method to query and send data between the client and the resource. That is, the client uses the HTTP calls to request the data from a resource. Preferably, the resource, in particular the energy measuring device, contains the REST API service. The data or response is preferably output in the JSON (Java Script Object Notation) data format. This is a plain text output that can also easily be read by human beings. Of course, another HTTP-compliant format, such as XML (Extensible Markup Language), or text format or another compliant format can also be used.

In one embodiment, the request from the receiving device contains a signature parameter, which indicates that the response is to contain the digital signature. Thus, if this signature parameter is included in the request, the API response includes the digital signature, for example in the form of the JSON object. The signature verifies the data integrity and authenticity of the sender.

In one embodiment, the Modbus protocol, in particular Modbus-RTU or Modbus-TCP, is implemented for the stateless communication. The Modbus protocol is a known communication protocol based on fieldbus. During the data transmission, a particular distinction is made between different operating modes, namely Modbus-RTU (Remote Terminal Unit) and Modbus-TCP (Transmission Control Protocol).

In Modbus-RTU, the data transmission is serial. The communication interface is configured in particular in a wired fashion. For example, the communication interface can comprise Ethernet. All common IP network topologies can be used for communication via Modbus-TCP. Communication takes place via the Internet Protocol (IP), preferably without cables or wires, in particular via radio. This means that the communication interface is preferably a radio interface.

In one embodiment, a group of memory cells (memory range) for storing the respective metering data and the digital signature is preconfigured and persistently stored for a memory unit of the energy measuring device. At the request of the receiving device, the contents of the group of memory cells are read out and transmitted as a response. This means that a user-defined range of memory cells is preconfigured or parameterized in order to make the communication using Modbus stateless.

Thus, all memory cells can be read out all at once or together with just one request via the Modbus protocol, without the memory cells having to be addressed individually. The metering data and the signature are transmitted together. The receiving device thus does not need to know the address of the memory cells and the request need not contain the address of the memory cells. The request only contains the read command for the metering data and the signature; the energy measuring device automatically reads the data from the appropriate memory range.

The pre-configuration of the memory range can be carried out, for example, in a setup phase, which is in particular independent of the subsequent data query. For this purpose, the receiving device can, for example, order the memory range configuration to be carried out by means of a request to the energy measuring device.

In one embodiment, the digital signature is dynamically generated. For this purpose, the metering data are first read out from respective memory cells of a memory unit of the energy measuring device in a loop in response to a repeated request and transmitted as a response. In response to a final request, the digital signature is generated and read out from a preconfigured and persistently stored memory cell and transmitted as the response. After each of the repeated requests, a hash value over the metering data is updated and after the signature is generated, the hash value is initialized in order to be provided for a new data query in a further loop pass. The loop can be performed once or multiple times depending on the amount of metering data.

In other words, in the loop, i.e. a repetition or round, read requests to read the metering data from the receiving device are made multiple times, depending on the amount of metering data. After each request, the energy measuring device returns the corresponding metering data from any memory cell in which the metering data is stored. With each request the hash value is refreshed or updated. The final read request in the loop then contains the signature request. In this process, the unique signature address of the stored memory cell for the signature is addressed. The signature is then generated using the hash value and then the hash value is initialized or reset. In response, the generated signature is sent from the energy measuring device to the receiving device.

In one embodiment, the hash value is initialized once before a first pass of the loop. This is particularly advantageous with Modbus-TCP. This ensures that the hash value does not contain errors at the start of the readout process and that no problems can arise in the verification or identification of the metering data.

In one embodiment, when using Modbus-RTU, the responses to requests in a first round of the loop are discarded. This means that the first loop pass is discarded as a dummy read or not saved. This ensures that an erroneous hash value cannot be used for data verification. After the first pass of the loop, the hash value is automatically initialized by generating the signature and can thus be assumed to be error-free for the subsequent loop passes. Alternatively, it is of course conceivable to initialize or reset the hash value explicitly before the first loop pass, even in the case of communication using Modbus-RTU.

For application cases or application situations that may arise in a method according to the invention and that are not described explicitly here, provision may be made, according to the method, for an error message and/or a request for input of user feedback to be output and/or a default setting and/or a predetermined initial state to be set.

According to one aspect, the invention relates to an energy measuring device for transmitting signed metering data to a receiving device. The energy measuring device comprises a sensor unit for collecting metering data. The sensor unit may comprise, for example, one or more sensors, such as a current sensor and a voltage sensor. Preferably, the sensor unit also comprises a data processing unit. With the data processing unit, the measured values from the sensors can be processed, in particular converted, for example into an energy value or power value. The data processing unit can therefore perform calculations with the measured values of the sensors in order to obtain, for example, the energy meter readings.

In the present disclosure, a data processing unit may be understood, for example, as a device having processing circuits for processing data. A data processing unit can therefore perform computational operations to process data. Indexed access to a data structure, such as a look-up table, LUT, or a database, can also be considered a computational operation. A partial or complete processing of data implemented in hardware can also be considered a computational operation.

In particular, a data processing unit may contain one or more computers, one or more microcontrollers and/or one or more integrated circuits, for example one or more application-specific integrated circuits (ASICs), one or more field-programmable gate arrays (FPGAs) and/or one or more systems on a chip (SoCs). A data processing unit may also contain one or more processors, for example one or more microprocessors, one or more central processing units (CPUs), one or more graphics processing units (GPUs) and/or one or more signal processors, in particular one or more digital signal processors (DSPs). The data processing unit may also contain a physical or virtual cluster of computers or other instances of the stated units.

A data processing unit may also comprise one or more hardware and/or software interfaces, for example, for receiving and/or providing data.

Furthermore, the energy measuring device comprises an encryption unit for generating a digital signature over the metering data. For example, the encryption unit can be implemented in software and/or hardware. It can also be understood as a cryptographic unit. For example, the encryption unit can be implemented as a TPM (Trusted Platform Module).

Furthermore, the energy measuring device comprises a memory unit for storing the metering data and the digital signature.

A memory unit may be designed as a volatile data memory, for example as a dynamic random access memory (DRAM) or a static random access memory (SRAM), or as a non-volatile data memory, for example as a read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random access memory (MRAM) or as a phase-change random access memory (PCRAM).

In addition, the energy measuring device comprises a communication unit which forms a communication interface for transmitting the metering data and the signature to the receiving device. The communication for the transmission in this case is in a stateless form, by the communication unit being designed to transmit the metering data and the signature as a response immediately upon a request from the receiving device without the exchange of session data.

The communication unit may comprise one or more modules for data transmission. For example, a module can be designed as a radio module. The metering data and the signature can thus be transmitted by radio using a suitable radio interface. For example, the radio transmission may be based on WLAN, Bluetooth, NFC, mobile radio communication, or any other wireless or cable-less transmission protocol. Alternatively, the communication module can be implemented using wires or cables. For example, the module may comprise an Ethernet standard-based interface.

That is, the energy measuring device can be used to carry out or perform a method according to the invention. Preferably, the energy measuring device carries out or performs the method according to the invention.

According to one aspect, the invention relates to a receiving device for receiving signed metering data from an energy measuring device according to the invention. The receiving device also comprises a communication unit similar to that of the energy measuring device. The communication unit forms a communication interface for radio-based reception of the metering data and the signature from the receiving device. The communication for the transmission is in a stateless form, by the communication unit being designed to receive the metering data and the signature as a response immediately upon a request from the receiving device without the exchange of session data.

According to one aspect, the invention relates to a system comprising at least one energy measuring device according to the invention and a receiving device according to the invention. The respective energy measuring device is coupled with the receiving device by means of a communication interface for the transmission, i.e. the exchange of the metering data and the signature between the two terminals.

Further embodiments of the energy measuring device according to the invention, the receiving device according to the invention and the system according to the invention follow directly from the various embodiments of the method according to the invention and vice versa. In particular, individual features and corresponding explanations as well as advantages with regard to the various embodiments of the method according to the invention can be transferred analogously to corresponding embodiments of the other subjects according to the invention.

Further features of the invention will become apparent from the claims, the figures and the description of the figures. The features and combinations of features cited above in the description and the features and combinations of features cited below in the description of the figures and/or shown in the figures may be encompassed by the invention not just in the respectively specified combination, but also in other combinations. In particular, embodiments and combinations of features which do not have all the features of an originally formulated claim may also be encompassed by the invention. In addition, embodiments and combinations of features which go beyond or deviate from the combinations of features specified in the claims may include the invention.

Other features which are considered as characteristic for the invention are set forth in the appended claims.

Although the invention is illustrated and described herein as embodied in transmitting signed metering data from an energy measuring device to a receiving device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic block circuit diagram of a system for transmitting signed metering data from an energy measuring device to a receiving device;

FIG. 2 shows a schematic sequence diagram for data exchange between the energy measuring device and the receiving device according to a first exemplary embodiment;

FIG. 3 shows a schematic sequence diagram for an exemplary data exchange between the energy measuring device and the receiving device according to a second exemplary embodiment; and

FIG. 4 shows a schematic sequence diagram for an exemplary data exchange between the energy measuring device and the receiving device according to a third exemplary embodiment.

Identical or functionally identical elements are provided with the same reference signs throughout the drawing figures. The description of identical or functionally identical elements is not necessarily repeated in all of the different figures.

### DETAILED DESCRIPTION OF THE INVENTION

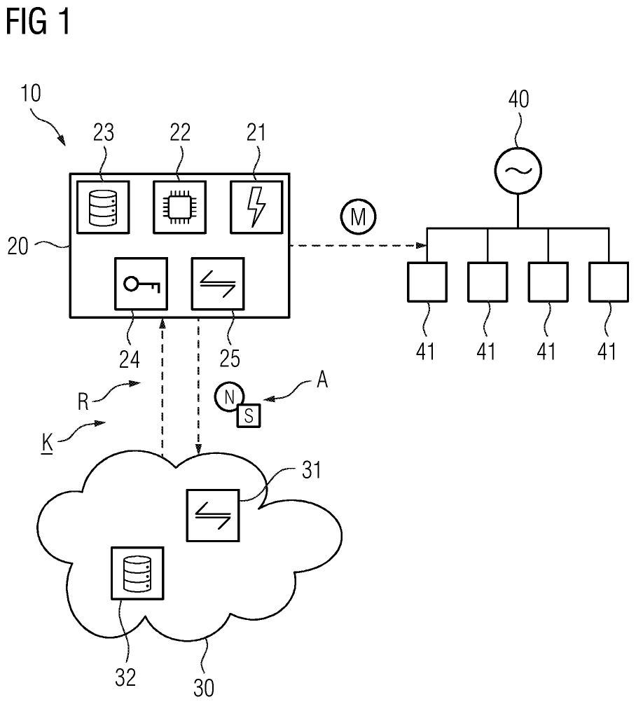

Referring now to the figures of the drawing in detail and first, in particular, to FIG. 1 thereof, there is shown in schematic illustration a block diagram of a system 10 for transmitting or exchanging signed metering data N of an energy measuring device, or energy meter, 20 to or with a receiving device 30. The energy meter 20 is preferably a calibratable or MID-compliant measuring device, which is designed to allow energy meter readings from one or more consumers 41 to be read or read out. In the present exemplary embodiment the respective consumer 41 is connected to a power supply network 40 via a respective outlet. The power supply network 40 is used to distribute electrical energy to the respective consumer 41.

In the present exemplary embodiment, for example, four consumers 41 are shown or connected. Of course, more or fewer corresponding consumers 41 may also be provided. The electrical consumers 41 in the present case are configured to consume electrical energy which is provided via the power supply network 40. The electrical consumers 41 may be formed, for example, by manufacturing machines, electrical heating devices, office equipment, lighting devices and/or the like. Alternatively, it can of course be provided that an electrical energy generator is connected instead of at least one of the consumers 41. An energy generator can be, for example, a solar energy system, a wind turbine, a combustion engine-driven electric generator and/or the like.

The energy measuring device 20 is now to be used to measure the energy or power consumed by the consumers 41. In the present exemplary embodiment, only one such energy measuring device 20 is shown. Of course, more than one energy measuring device 20 may be provided by the system 10. For example, a separate energy measuring device 20 may be present for each consumer 41.

For measuring the energy or power consumption, in the present case the energy measuring device 20 comprises a sensor unit 21. The sensor unit 21 may comprise one or more sensors to measure or collect electrical measured values M of the consumers 41, which are assigned to or related to the energy consumption. The sensor unit 21 is thus designed as a meter for determining the energy consumed. Measured values include, for example, an electric current and/or voltage. Each sensor can therefore be designed as a current or voltage sensor.

In addition, the energy measuring device 20 in the present exemplary embodiment comprises a data processing unit 22. The data processing device 22 may comprise at least one microcontroller and perform computational operations for processing the measured values M. For example, the data processing device 22 can be used to determine, in a known manner, the energy or power consumed by the respective consumer 41 from the measured values M, that is, the measured current and the measured voltage. The energy, power, current and/or voltage can be provided together or separately as respective meter readings of the energy measuring device 20.

In the following, these values are also referred to as the measurement data or metering data N. In addition to the energy-relevant values, the metering data N can also include time information, such as the time or date of the recorded or generated values, for example. A further content of the metering data N may include, for example, an identification of the energy measuring device 20 which carried out the collection of the metering data N.

In addition, the energy measuring device 20 also comprises an encryption unit 24. The encryption unit 24 can perform a cryptographic encryption function. The encryption unit 24 can therefore also be referred to as a cryptochip. In particular, its purpose is to generate a digital signature S over the metering data N by means of the encryption unit 24. For this purpose, the encryption unit uses, for example, a cryptographic hash function (variance coefficient function), which is used to generate a hash value over the metering data N. Preferably, this is a key-dependent hash function in which the digital signature is encrypted by means of public key authentication. The public key encryption can also be performed using the encryption unit 24. For this purpose, the encryption unit may comprise appropriately known software and/or hardware modules. The digital signature S enables the authenticity and integrity of the metering data N to be ensured.

The digital signature S thus generated and the metering data N are then stored in a memory unit 23 of the energy measuring device 20 for later use. The memory unit 23 may preferably be designed as a non-volatile data memory or comprise at least one data memory portion which is designed as a non-volatile data memory.

The signed metering data N is then intended to be stored in a central database, for example, for audit or verification purposes. For this purpose, the signed metering data N is transmitted or sent from the energy measuring device 20 to the receiving device 30 by means of a communication interface K. The receiving device 30 also comprises, for example, a memory unit 32, which can be configured as a corresponding database or, for example, as a cloud server.

In order to establish the communication link, the energy measuring device 20 and the receiving device 30 each have a communication unit 25, 31, which can be used to establish the corresponding communication link. The communication between energy measuring device 20 and receiving device 30 is bi-directional. This means that both the energy measuring device 20 and the receiving device 30 can send and receive data.

For example, the receiving device 30 can make a request R or a call to the energy measuring device 20. For example, the call can contain the query for the signed metering data N. The energy measuring device 20 can send a response A in response to the request R. For example, the response A contains the signed metering data N. The metering data N and the signature S can be exchanged or transmitted sequentially or jointly, that is, on the basis of multiple successive requests R and responses A, or jointly on the basis of a single request R and a resulting response A.

The communication interface K can be wireless or wired, or wire- or cable-bound. For example, the wireless transmission is performed by radio. The data is exchanged by means of radio signals, for example on the basis of mobile radio or WLAN. The communication units 24, 31 can accordingly comprise a radio module, for example an antenna module. In the cable-bound variant, data exchange takes place, for example, via a direct connection or electrical line between the receiving device 30 and the energy measuring device 20. The communication units 25, 31, for example, may comprise an Ethernet interface.

In order to enable the request R of the signed metering data N to be executed particularly simply and preferably automatically, for example by means of a script, it is also provided in the present case that the communication for the transmission is in a stateless form. This means that the metering data N and the signature S are transmitted immediately as response A upon the request R of the receiving device 30 without an exchange of session data. The response thus consists of two objects. A first object comprises the metering data N and a second object comprises the digital signature S. The transmission can thus be read out independently of the receiving device or of the respective software or architecture that the energy measuring device 20 and the receiving device 30 use.

In order to implement stateless communication, two different variants for communication protocols or architectures are presented below:

In one variant, the stateless communication takes place, for example, using a REST API. Data transmission via the communication interface K takes place using the HTTP protocol. This means that the communication interface K is preferably a wireless interface. The communication nodes are equipped for the use of TCP/IP. In this case, the REST API service can be provided, for example, by the energy measuring device 20, in particular the data processing device 22 thereof. The receiving device 30 uses the REST API including the corresponding commands for the query. Preferably, the response A is output in the JSON data format.

In this variant, the API contains a signature parameter (sign=1) that triggers the output of the digital signature S in the API response A. The public key, which is required for verification of the signature S, can also be retrieved from the measuring device 20. An example of a query R of the signed metering data N may have the following form:
GET /data.json? type=COUNTER&sign=1 HTTP/1.1
Host: <device-ip>

The response A may look like this:
{
“COUNTER”: {
   // Metering data N
   },
“COUNTER_SIGNATURE”: “Base64-encoded digital signature”
   // digital signature S
}

Thus, if the metering data N is retrieved from the host, in this case the respective energy measuring device 20, with the Get command and the signature parameter sign=1 is included in the query R, the response A contains the digital signature S of the JSON object (metering data), which is identified by the key counter. This signature S verifies the data integrity and authenticity of the source location, i.e. the energy measuring device 20. Preferably, the calculated signature S should not include the curly brackets or any part of the field “COUNTER_SIGNATURE” in the calculation of the signature S. The receiving device 30 should match the signature S against the “Counter data” immediately upon receipt to verify the integrity and authenticity.

In order to retrieve the public key for verification of the signature S, the following example query R can be made by the receiving device 30:
Get/publickey1.pem Http/1.1
Host: <device-ip>

In this case, the public key is provided in the PEM format (Privacy Enhanced Mail), which is suitable for most cryptographic libraries. A data matrix such as a QR-Code ID-link can be applied or lasered, for example, to the housing of the energy measuring device 20, to indicate the public key. This makes it possible to check the authenticity of the public key.

To use the public key, the public key must be securely stored on the energy measuring device 20 and only sent over a secure connection, in order to prevent interventions or changes. In addition, the public key should be verified at least once by physically viewing the energy measuring device, for example by reading the QR code from the housing.

Another variant for implementing stateless communication is the use of the Modbus protocol, in particular Modbus-RTU or Modbus-TCP. The energy measuring device 20 and the receiving device 30 are thus designed for communication by means of Modbus, in particular their communication units 25, 31. Depending on the Modbus variant, the data transmission is wireless or wired. With Modbus-RTU, the data is transmitted by cable, for example via a serial interface or via Ethernet. Modbus-TCP uses the Internet protocol to transmit data wirelessly.

Traditional Modbus protocols do not in themselves provide a way to enable data integrity and authentication in a stateless manner. In this document, only two options are proposed in which the stateless communication can nevertheless be implemented.

A first option is to configure a user-defined range for the metering data and signature memory of the memory unit 23. The option with the user-defined memory range can be used equally well for Modbus-RTU as for Modbus-TCP. In this case a block or group of registers or memory cells within this range is used to dynamically store the metering data N and signature S on each request R. This is particularly useful if users wish to read out the same metering data N repeatedly, such as energy meter readings for MID-compliant energy measuring devices, for example for billing or audit purposes.

The memory range, i.e. the group of memory cells 23', is stored persistently. The configuration preferably contains the start address and length of each register block and ends with the specification of the register address and the length of the digital signature S. Preferably, the maximum length of the configuration is 240 bytes. Using this configuration means that multiple addresses of the memory unit 23 can be read out using the Modbus protocol without addressing the memory cells or registers separately. Thus, only one request R is required to obtain the response A with the signed metering data N.

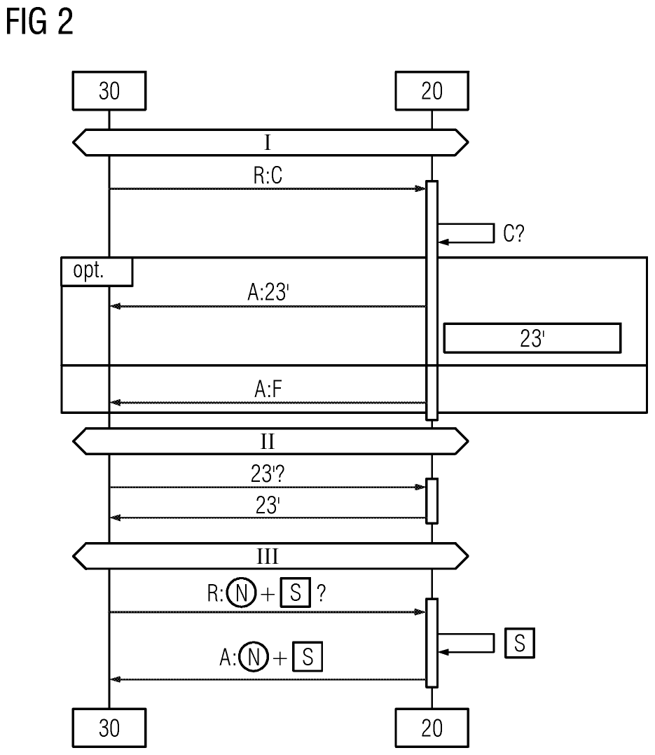

FIG. 2 shows an exemplary schematic sequence diagram for data transmission between the receiving device 30 and the energy measuring device 20 when the user-defined memory range is used.

The diagram first shows a configuration phase I. In this phase, the receiving device 30 sends a configuration command C as request R to the energy measuring device 20. This validates the configuration data contained in the command C. If the configuration data is valid, the energy measuring device 20 generates the corresponding memory range, i.e. the group of memory cells 23′ within the memory unit 23. As the response A, the energy measuring device 20 then sends an acknowledgment and, for example, the memory configuration, which contains the addresses of the group of memory cells 23′, for example. However, if the configuration data or the configuration is invalid, the group of memory cells 23′ is not created and the energy measuring device 20 sends an error message F as the response.

This completes the configuration phase I and the configuration is pre-programmed and the memory range is stored persistently. The configuration phase I only needs to be performed once to set the memory range accordingly. Then, once the memory range has been initialized, the memory range can be accessed again and again.

In the exemplary embodiment according to FIG. 2, a runtime phase II is also implemented before the metering data N is read out. This involves reading out the current configuration of the memory with the group of memory cells 23′. To do this, the receiving unit 30 places a request to read out the current configuration. In response, the energy measuring device 20 returns the current configuration of the group of memory cells 23′. The runtime phase II can be carried out in each pass of reading the metering data N or only in selected passes or once for each receiving device 30.

The runtime phase II is followed by a request phase III. This can be repeated as many times as required for requesting metering data. In the request phase III, the receiving device 30 sends the request R to read out the signed metering data N to the energy measuring device 20. The energy measuring device 20, which has stored the metering data N in the preconfigured memory range with the group of memory cells 23', then calculates the signature S over the group of memory cells 23′ which contain the metering data N. For this purpose, the energy measuring device 20 uses the hash function and generates, for example, a hash value H. The generated signature S is also stored in a memory cell of the group of memory cells 23′. Subsequently, the entire data packet consisting of the signed metering data N is transmitted from the energy measuring device 20 to the receiving device 20 as response A.

Another option involves generating the digital signature S dynamically. A distinction must be made here between Modbus-TCP and Modbus-RTU for stateless communication.

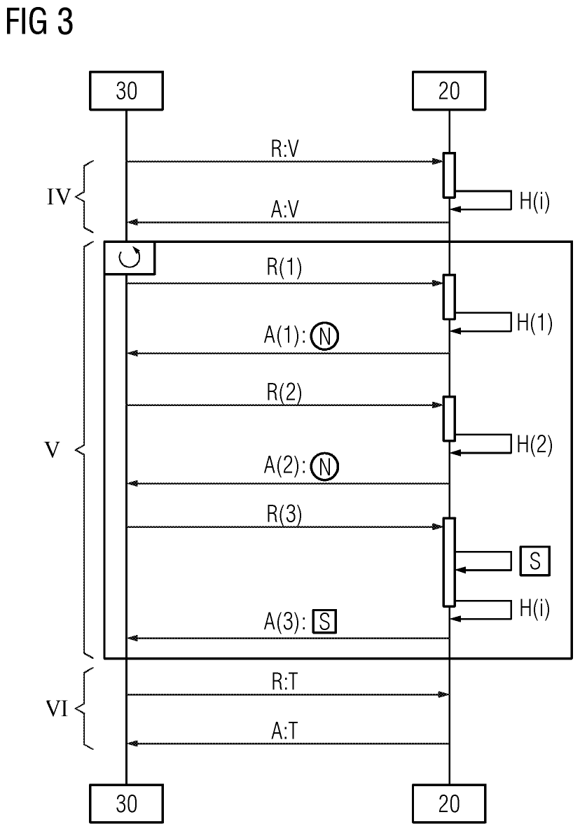

FIG. 3 shows an example sequence diagram for data transmission between the energy measuring device 20 and the receiving device 30 for dynamic generation of the signature S using Modbus-TCP.

The TCP connection is first established in a connection phase IV. To this end, the receiving device 30 sends a TCP connection command K to the energy measuring device 20. The energy measuring device 20 then initializes the hash value H(i) once. This initialization or reset is necessary for each session to retain its unique security features or security attributes.

Thereafter, the energy measuring device 20 confirms the connection establishment with a corresponding response A. A request phase V then takes place. The request phase V is implemented, for example, as a loop and can thus be repeated as often as desired. For example, the number of repetitions depends on the desired amount of metering data N. In the request phase V, the metering data N is now queried with corresponding queries R(1), R(2). A separate read command is required for each memory cell of the memory unit in which metering data N is stored. After each query R, the hash value over this new data is updated (H(1), H(2)). After updating the hash value H(1), H(2), the energy measuring device 20 sends the metering data N of the respective allocated memory cell or addressed memory address as the respective response A(1), A(2). For example, in a first response A(1), the date can be transmitted as metering data N, while in a subsequent response A(2), the meter reading is transferred.

The final request R(3) in the loop contains a read command for the signature S. The energy measuring device 20 generates the signature S by forming the hash value over the whole of the metering data N. The signature S can then be read from a known address within the Modbus memory range of the memory unit 23 after the registers with the metering data N have been read out during the TCP session. Reading the signature S also has the effect that the hash value H(i) is re-initialized or reset. As the response A(3), the energy measuring device 20 then returns the calculated signature S.

In the present exemplary embodiment, for example, two read requests and then the signature request are shown. Of course, more or fewer read requests may also be included in the query phase V.

After the query phase V, a disconnection phase VI follows, in which the TCP connection between the communication nodes is disconnected. In this event, the receiving device 30 sends a disconnect command T as a request R and the energy measuring device 20 sends a confirmation that the TCP connection has been disconnected as the response A.

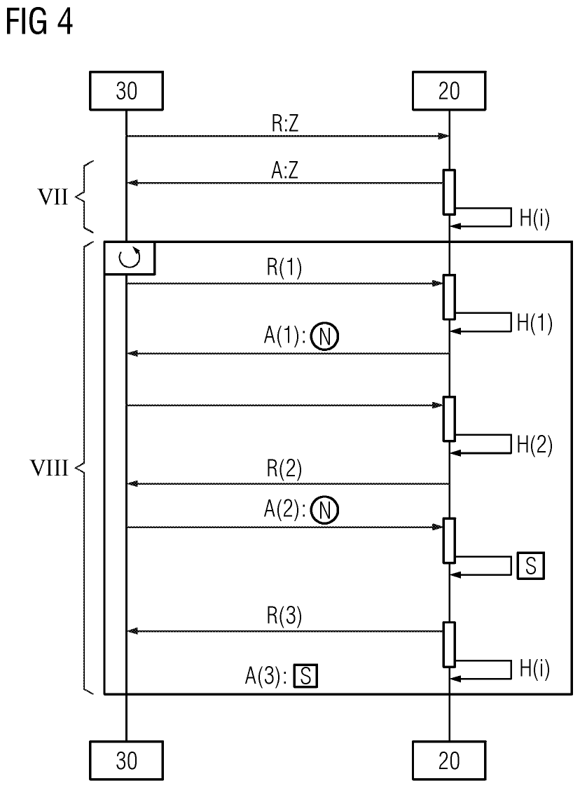

FIG. 4 shows a schematic sequence diagram for the data transmission between the energy measuring device 20 and the receiving device 30 for dynamic generation of the signature S using Modbus-RTU. Since Modbus-RTU provides connectionless communication, it is important to reset or initialize the hash value H for the signature generation once to avoid it becoming incorrect after the first pass. For example, the reset can be carried out in a reset phase VII (reset phase). In the reset phase, the receiving device 30 sends a reset command Z as a request, i.e. a command to reset or initialize the hash value H. For this purpose, the so-called reset-hash command for the Modbus protocol is used, for example. As a response, the energy measuring device 20 sends a confirmation and initializes the hash value H(i).

This is followed by a request phase VIII. This can be executed as a loop in the same way as the exemplary embodiment in FIG. 3. The request phase VIII is structured in a similar way to the query phase V according to FIG. 3. This means that requests R(1), R(2) to query the metering data N are sent repeatedly, whereupon the hash value H(1), H(2) is updated. The response A(1), A(2) then contains the metering data N. In a final request R(3), the signature is queried by reading out the memory address provided for the signature S. The energy measuring device 20 then generates the signature S accordingly and returns it as response A(3). The hash value H(i) is then initialized again.

Since the hash value H(i) is also initialized at the end of the request phase VIII, it is conceivable to discard the first pass of the query phase V as a so-called dummy read. With the second pass, the hash value is then initialized and can be assumed to be error-free.

Overall, the exemplary embodiments show a calibratable energy measuring device 20 with a signed data interface.

The following is a summary list of reference numerals and the corresponding structure used in the above description of the invention:
10 system
20 energy measuring device
21 sensor unit
22 data processing unit
23 memory unit
23′ group of memory cells
24 encryption unit
25, 31 communication unit
30 receiving device
32 memory unit
40 power supply network
41 consumer
A, A(1)-A(3) response
C configuration command
F error message
H(i) initialized hash value
H(1), H(2) updated hash value
K communication link
M measured values
N metering data
R, R(1)-R(3) request
S digital signature
T disconnect command
V connection command
Z reset command
I configuration phase
II runtime phase
III, V, VIII request phase
IV connection phase
VI disconnection phase
VII reset phase

1. A method for transmitting signed metering data from an energy measuring device to a receiving device, the method comprising:
collecting and storing the metering data by the energy measuring device;
generating and storing a digital signature over the metering data ; and
sequentially or jointly transmitting the metering data and the signature from the energy measuring device to the receiving device by way of a communication interface, wherein a communication for the transmission is in a stateless form, and the metering data and signature are transmitted as a response immediately upon a request by the receiving device without an exchange of session data.

2. The method according to claim 1, which comprises generating the signature by way of a cryptographic hash function.

3. The method according to claim 2, which comprises encrypting the signature by public key authentication.

4. The method according to claim 1, which comprises implementing a Representational State Transfer Application Program Interface for the stateless communication, and effecting the transmission by way of a hypertext transfer protocol.

5. The method according to claim 4, wherein the request from the receiving device contains a signature parameter, which indicates that the response is to contain the digital signature.

6. The method according to claim 1, which comprises implementing a Modbus protocol for the stateless communication.

7. The method according to claim 6, wherein the Modbus protocol is a Modbus-RTU or Modbus-TCP protocol.

8. The method according to claim 6, which comprises preconfiguring and persistently storing a group of memory cells for storing the metering data and the digital signature for a memory unit of the energy measuring device, and upon the request of the receiving device, reading out and transmitting a content of the group of memory cells as a response.

9. The method according to claim 2, which comprises dynamically generating the digital signature by first reading the metering data from respective memory cells of a memory unit of the energy measuring device in a loop in response to a repeated request and transmitting as a response and, in response to a final request, by generating the digital signature and reading from a preconfigured and persistently stored memory cell and transmitting as the response, and, after each of the repeated requests, updating a hash value, H(2)) over the metering data and initializing the hash value) is initialized after generating the signature.

10. The method according to claim 9, which comprises initializing the hash value) once before a first pass of the loop.

11. The method according to claim 9, which comprises implementing a Modbus-RTU protocol for the stateless communication, and discarding the responses to requests in a first round of the loop.

12. An energy measuring device for transmitting signed metering data to a receiving device, the energy measuring device comprising:
a sensor unit for collecting metering data;
an encryption unit for generating a digital signature over the metering data;
a memory for storing the metering data and the digital signature;
a communication unit configured to form a communication interface for transmitting the metering data and the signature to the receiving device, wherein a communication for the transmission is in a stateless form, and said communication unit is configured to transmit the metering data and signature as a response immediately upon a request of said receiving device without an exchange of session data.

13. A receiving device for receiving signed metering data from the energy measuring device according to claim 12, the receiving device comprising:
a communication unit configured to form a communication interface for receiving the metering data and signature from the energy measuring device, wherein a communication for the transmission is in a stateless form and said communication unit is configured to receive the metering data and signature as a response immediately upon sending a request to the energy measuring device without an exchange of session data.

14. A system, comprising:
at least one energy measuring device for transmitting signed metering data, a receiving device for receiving the signed metering data, and a communication interface communicatively connecting said m;
said energy measuring device having:
a sensor unit for collecting metering data, an encryption unit for generating a digital signature over the metering data, and a memory for storing the metering data and the digital signature;
a communication unit configured to form a communication interface for transmitting the metering data and the signature to said receiving device, wherein a communication for the transmission is in a stateless form, and said communication unit of said energy measuring device is configured to transmit the metering data and signature through said communication interface as a response immediately upon a request of said receiving device without an exchange of session data;
said receiving device having:
a communication unit configured to receive the metering data and signature from the energy measuring device through said communication interface as a response immediately upon sending the request to said energy measuring device without the exchange of session data.
